(19) United States
(12) Patent Application Publication
(10) Pub. No.: US 2010/0027608 A1
(43) Pub. Date: Feb. 4, 2010

(54) Scrambled multicarrier transmission

(76) Inventor: Paolo Priotti, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/311,353

(22) PCT Filed: Sep. 29, 2006
(86) PCT No.: PCT/EP2006/009469

§ 371 Date: Aug. 12, 2009

(51) Int. Cl. H04L 27/28; H04B 7/02; H03H 7/30; H04L 27/00; H03D 1/00; H04L 9/00

(52) U.S. Cl. 375/232; 375/260; 375/267; 375/299; 375/340; 380/268

(57) ABSTRACT

Signals (typically in the form of OFDM signals) are transmitted between one or more transmitting antennas and one or more receiving antennas. The signals transmitted are subject to addition of a guard interval before scrambling in the time domain, while the signals received are subject to removal of the guard interval after scrambling in the time domain. Preferably time-scrambling of the OFDM signal being transmitted occurs after IFFT processing and guard interval insertion, while time de-scrambling of the signal being received occurs before both guard interval removal and FFT processing. Optionally, unscrambled pilot symbols (e.g. in the form of a training sequence), can be present at regular intervals inside the signal structure. At the receiver, equalization is carried out preferably in the frequency domain.

### FIELD OF THE INVENTION

The invention relates to radio communication systems and more specifically to digital multicarrier communication systems.

### DESCRIPTION OF THE RELATED ART

Cellular phone systems and portable/mobile terminals using cellular transmission techniques have evolved over the years from analogue narrowband transmission (also known as 1^{st} generation), to digital narrowband transmission (2^{nd} generation or 2G) and on to digital broadband transmission (3^{rd} generation or 3G). Further evolution towards still higher data rates can be based on improvements in the spectral efficiency of the transmission system. However, given the inevitable limits on spectral efficiency, an increase in the transmission bandwidth is foreseen for future generations of cellular phones. Such an increase in the transmission bandwidth typically entails an increase in the receiver circuit complexity, which depends i.a. on the type of modulation and multiplexing adopted. For instance, 3G systems, based on the CDMA (Code-Division Multiple Access), operate well on bandwidths up to several MHz. Values in the range 20 to 40 MHz are often considered as an upper limit for the bandwidth of low-cost commercial CDMA equipment using a RAKE receiver.

When the bandwidth of a transmission system becomes larger than a few MHz, a multicarrier modulation is often more suited for low-complexity implementations. In particular, OFDM (Orthogonal Frequency Division Multiplexing) has been shown to be particularly adapted for cost-efficient transceivers where the signal is processed essentially in the frequency domain both in transmit-side and receive-side baseband circuits. In OFDM, the transition from the frequency domain to the time domain and vice versa is typically performed with low-cost Inverse Fast Fourier Transform (IFFT) and Fast Fourier Transform (FFT) operators. Moreover, OFDM has a particularly convenient way of using the frequency spectrum: this is due to the fact that subcarriers do not interfere reciprocally even if they have partially overlapping spectra.

In areas different from the cellular world, where support for high mobility is not mandatory, transmitters have evolved earlier towards large bandwidths. By way of example, Wireless Local Area Networks (W-LANs) complying with the IEEE802.11 family of standards use a 20 MHz channel, and transmit with a 64-subcarrier OFDM modulation. In the case of W-LANs, transmission is governed by a MAC (Medium Access Control) protocol that avoids transmission when a given frequency channel is already in use (CSMA-CA, Carrier Sense Multiple Access with Collision Avoidance). For this reason, within a given W-LAN cell there is usually no direct co-channel interference between different transmitters. Moreover, in a “hot-spot” kind of territory coverage, cells are usually physically separated, so that in most instances interference from and towards other cells is very limited.

Reverting to the cellular world, research in that area is moving towards new generation systems having a wider bandwidth than 3G. Specifically, the generations currently referred to as Super 3G (S3G) or 3GPP LTE (Long Term Evolution) and 4′ generation (4G) might use an OFDM-based physical layer; consequently, OFDM could find use in very different environments compared to W-LANs. In the following, reference will be made primarily to S3G transmission systems: this is just by way of example and without losing generality in discussing the background and the features of the invention described herein.

The type of continuous coverage required by a cellular system will cause the signal transmitted “downlink” (DL) by a base-station or uplink (UL) by a terminal to overlap the service area of neighbouring cells. Demands for high spectral efficiency, on the other hand, practically make it impossible in this context to adopt frequency reuse as in 2G networks. In S3G networks the frequency reuse factor will thus be low, if not unitary. In S3G, and especially at the cell edge, very strong co-channel interference will be likely, which will substantially lower user throughput if not properly mitigated.

FIG. 1 of the annexed drawing is an exemplary graphical representation of the situation that gives rise to inter-cell interference in a Frequency Division Duplexing (FDD) system. Specifically, the left-hand portion of the figure, designated a), refers to downlink (DL) transmission, while the right-hand portion of the figure, designated b), refers to uplink (UL) transmission. Two base stations BTS1, BTS2 and two mobile terminals or user equipments UE1, UE2 are shown by way of example. The lines B are schematically representative of the theoretical border between cells. Solid arrows denote the useful signal, while dashed arrows denote unwanted interfering signals. Those of skill in the art will promptly appreciate that an equivalent interference scenario, in a Time Division Duplexing (TDD) system, could arise in IEEE802.16 networks (e.g. WiMAX) and the like, where a continuous coverage is achieved via hand-off procedure.

Inter-cell interference can be avoided or mitigated by layer 2 mechanisms (Radio Resource Management or RRM, intelligent packet scheduler), and by intelligent use of adaptive beamforming and power control. On the other hand, interference can be mitigated or cancelled once it has mixed with the useful signal, mainly through layer 1 mechanisms, like blind or semi-blind interference cancellation and Multi-User detection (MUD).

WO-A-2005/086446 (taken as a model for the preamble of Claim 1) discloses apparatus and system to scramble an OFDM signal in the time-domain at the transmit side and perform its detection at the receive side. The transmitter is a conventional OFDM transmitter, but for the fact that the signal undergoes a time-domain scrambling after the IFFT and before insertion of a Guard Interval (GI). As a first step after GI removal, the receiver implements a FFT operation to transpose the signal to the frequency domain. The signal is then equalized in the frequency domain and re-converted to time domain via an IFFT operation. At this point time-domain de-scrambling is performed. De-scrambling is followed by FFT, demodulation, rate-matching and possible channel decoding.

### OBJECT AND SUMMARY OF THE INVENTION

Despite certain merits in terms of improved throughput and possible improvement in the channel estimation accuracy, the Applicant has observed that prior art arrangements as represented by WO-A-2005/086446 have a number of inherent weaknesses.

Specifically, the Applicant has tackled the following drawback and problems inherent in the prior art:
in the prior art, time scrambling is applied—before—GI insertion and, as a result, the transmitted signal has a periodic component; this may somewhat alter the spectral properties of the transmitted signal;
the prior art suggests to perform equalization in the frequency domain—after—GI removal and FFT processing: this however assumes that symbol synchronization has already been acquired. In real-life OFDM systems, symbol timing recovery can become critical in the low Signal-to-Noise Ratio (SNR) area, and cannot always rely on GI autocorrelation: especially in those systems where the Guard Interval is relatively short, accurate synchronization could in fact be obtained by resorting to a training sequence (not subject to scrambling), but this solution would hardly be convenient in comparison with arranging the system so that the signal is scrambled in its entirety;
prior art arrangements as taught in WO-A-2005/086446 are useful primarily when an interfering signal with coloured spectrum is “whitened” at the receiver. However, OFDM systems usually adopt frequency interleaving and concatenated channel coding, so that interference whitening may not always lead to performance improvement; and
in receivers according to the prior art, no information about the interferers is usually recovered/reconstructed, and no interference mitigation processing is performed.

The Applicant has found that these drawbacks/problems can be at least partly overcome by means of a method having the features set forth in the claims that follow. The invention also relates, independently, to a corresponding transmitter and a corresponding receiver for use in such a method. Finally, the invention also covers a related computer program product, loadable in the memory of at least one computer and including software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Reference to “at least one computer” is evidently intended to highlight the possibility for the present invention to be implemented in a distributed/modular fashion.

The claims are an integral part of the disclosure of the invention provided herein.

A preferred embodiment of the arrangement described herein is thus a method of multicarrier transmission between one or more transmitting antennas and one or more receiving antenna; the signals (typically in the form of OFDM signals) transmitted, namely the signals forwarded towards the transmitting antenna(s), are subject to scrambling in the time domain—after, i.e. downstream of—the addition of the guard interval, and the signals received, namely the signals conveyed from the receiving antenna, are subject to de-scrambling in the time domain—before, i.e. upstream of—the removal of the guard interval.

A particularly preferred embodiment of the arrangement described herein is based on the concept of time-scrambling the OFDM signal transmitted after IFFT processing and GI (Guard Interval) insertion, while de-scrambling the OFDM signal received precedes GI removal and FFT processing. Scrambling/de-scrambling is typically achieved by time-wise multiplication with a scrambling sequence, having a pseudo-random statistical distribution and constant modulus. Optionally, unscrambled pilot symbols (e.g. in the form of a Training Sequence, TS), can be present at regular intervals inside the signal structure. At the receiver, equalization is first carried out in the time domain or, preferably, in the frequency domain. After equalization, the signal exempt from Inter Symbol Interference (i.e. ISI-free) can be descrambled in the time domain. Scrambling with different scrambling sequences in different cells leads to interfering signals being “whitened” after the descrambling in the interfered cell. Moreover, after descrambling, the useful signal includes a periodic component due to the GI, while the interfering signal is notionally aperiodic (or present just a very small periodic component). This means that the Guard Interval (GI), or part of it, and the corresponding samples in the data field, can be subtracted one from the others to obtain an estimate of the interfering signal apart from additive noise. Typically, the GI will not be used in its entirety for the estimation process. This is because the first samples are usually corrupted by the tail of the preceding OFDM symbol, while possible offsets in symbol timing recovery should also be taken into account. Averaging the absolute value of the spectra of the estimate of the interfering signal (or a scrambled version of the same), would give an estimate of the amplitude of the transmission channel existing between the interfering transmitter (be it base-station or terminal) and interfered receiver (base-station or terminal).

In the case where not just one dominant interferer is present that mixes with the useful signal, but rather a plurality of interferers are present, an estimate of the channel as seen by the overall interfering signal, or a part of the interferers, can be obtained depending on the type of statistical post-processing. An estimate of the amplitude of the transmission channel of the interfering signal, once available, can be used in several different ways. When the interference mitigation processing is performed in the receiver, without feedback sent to the transmitter, a semi-blind or iterative interference canceller can be implemented. Alternatively, the estimate of the transmission channel of the interferer can be fed back, possibly in a compressed/quantized format, to the transmitter of the useful signal. The transmitter can in turn use this information to maximise the Carrier-to-Noise (C/N) ratio at the receiver. For a typical transmission system that tries to maximize the throughput, more power can be allocated to the parts of the spectrum less affected by interference, at least until the capacity achievable on those parts has asymptotically reached the maximum bit-rate permitted by modulation and coding. Above that level, more transmit power can increasingly be allocated to parts of the spectrum affected by interference.

In the arrangement described herein time scrambling of the signals transmitted takes place after GI insertion and, as a result, the transmitted signal does not exhibit any periodic component. On the receiver side, equalization is performed (in the time domain or, preferably, in the frequency domain)—before, i.e.—GI removal and FFT processing.

The arrangement described herein can be used advantageously in systems such as OFDM systems that adopt frequency interleaving and concatenated channel coding. Moreover, information about the interferers can be obtained at the receiver thus permitting both interference mitigation processing at the receiver and closed-loop, receiver driven pre-equalization at the transmitter.

In the arrangement described herein information about the interfering signals is extracted without transmitting additional information on the downlink channel and/or using of signal processing to mitigate interference. Time-domain scrambling is performed on the whole transmitted signal (data—and—the Guard Interval) and not just on the data section of the OFDM signal. Information about the interferers is recovered/reconstructed at the receiver in order to perform interference mitigation processing.

Especially if used in combination with a power control mechanism (such as a slow-power control as expected to be used in OFDM-based future generation communication links), the arrangement described herein may help in increasing the C/N ratio and/or reducing the transmitted power required to achieve a given throughput. The reduction of transmitted power can reduce the average interfering power over the whole network, thus exerting a beneficial effect also on those terminals that are not equipped with interference mitigation function.

### BRIEF DESCRIPTION OF THE ANNEXED DRAWINGS

The invention will now be described, by way of example only, with reference to the enclosed figures of drawing, wherein:

FIG. 1 has already been discussed in the foregoing,

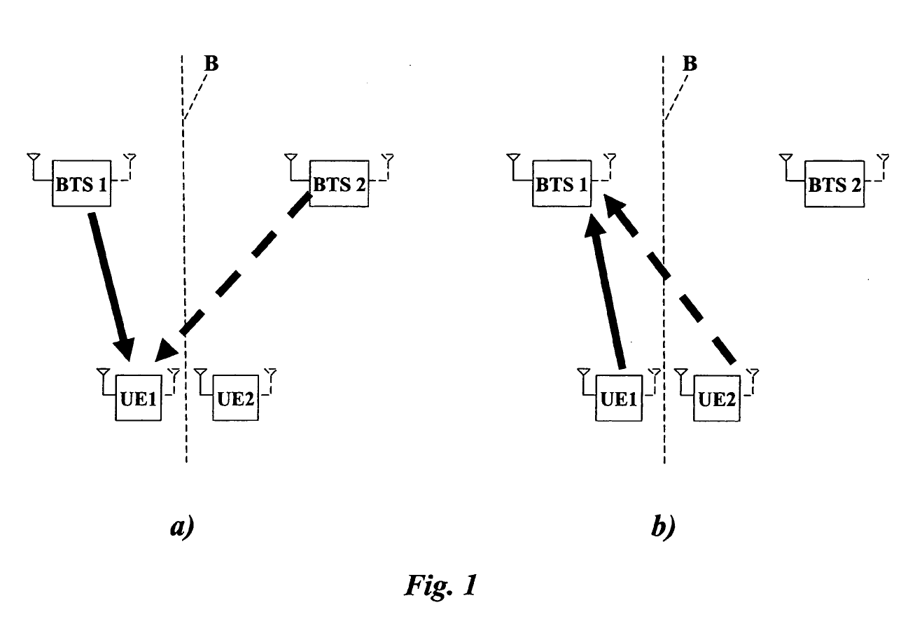

FIG. 2 includes two sections labelled a) and b) comprised of block diagrams of the transmitter and receiver sections, respectively, of a first embodiment of a system as described herein, and

FIG. 3 is a detailed block diagram of a preferred embodiment of one of the blocks illustrated in FIG. 2.

### DETAILED DESCRIPTION OF PREFERRED EMBODIMENTS OF THE INVENTION

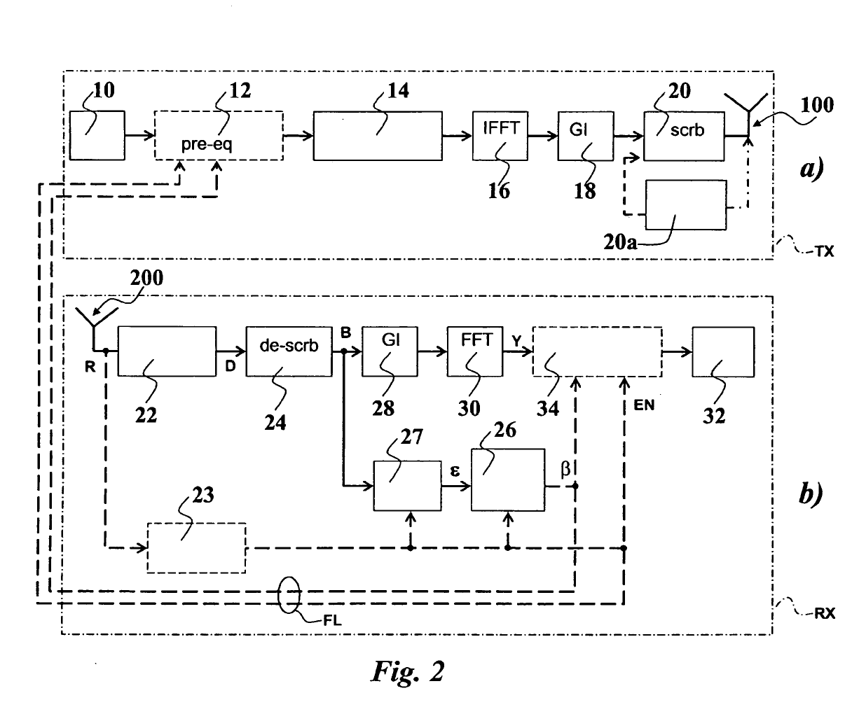

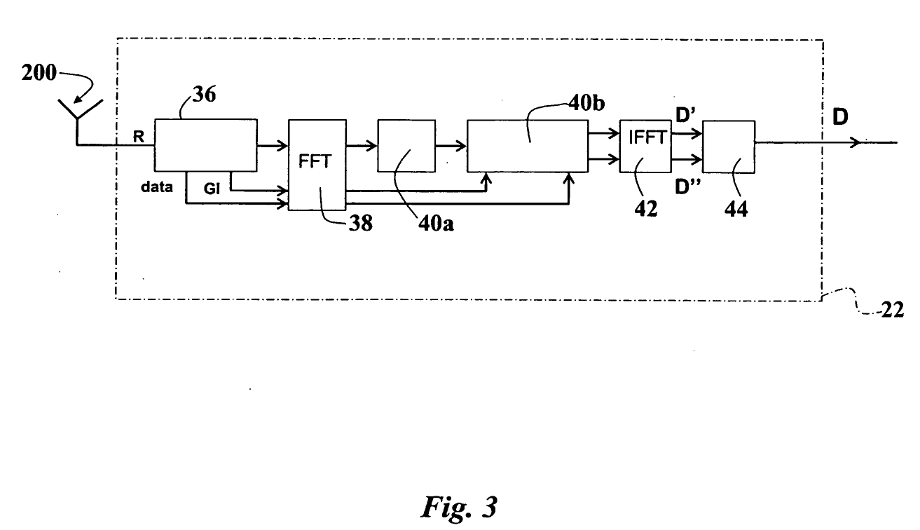

The exemplary transmission system described herein is an OFDM multi-carrier transmission system equipped with a SISO (Single-Input Single-Output) or MIMO (Multiple-Input Multiple-Output) antenna system. For generality, the system will be assumed to operate with N subcarriers, M_{T} transmit (TX) antennas (designated collectively as 100 in both FIGS. 2 and 3) and M_{R} receive (RX) antennas (designated collectively as 200 in both FIGS. 2 and 3).

The data part of the signal at the m-th TX antennas can be expressed as:

$${x}_{m} ( t ) = \frac{1}{N} {s}_{m} ( t ) {\sum }_{n = 0}^{N - 1} {X}_{m} ( n ) {e}^{j 2 π nt / N} , m = 1 … {M}_{T} \qquad ( 1 )$$

where sₘ is a complex scrambling sequence. This sequence can be specific for the m-th TX antenna of a given BTS or be cell-specific or sector-specific. The sequence can have a time period equal to one or more OFDM symbols (in practical implementations could be as long as a Transmission Time Interval TTI) and will typically have a unitary module. Certain points on the periodicity of the scrambling sequence will be further discussed in the rest of this description.

The signal at the p-th RX antenna can be expressed as:

$${r}_{p} ( t ) = {\sum }_{m = 1}^{{M}_{T}} {\sum }_{l = 1}^{Δ - 1} {c}_{l}^{mp} ( t ) {x}_{m} ( t - 1 ) + {v}_{p} ( t ) , p = 1 … {M}_{R} , \qquad ( 2 )$$

where Δ represents the delay spread of the channel, cₗ^{mp} is the complex channel coefficient for the l-th path in the sub-channel connecting m-th TX antenna to p-th RX antenna, vₚ represents the interference and noise contribution at the p-th RX antenna and will typically include one or more “colored” interferers and a “white” Gaussian noise contribution:

vₚ(t)=iₚ(t)+n(t) (3).

The notation used in the formulas (1) to (3) has the advantage of making it easier to understand the contribution of each transmit antenna to the received signal. However, a matrix notation can be simpler for representing a Guard Interval (GI), and in the following such a notation will be used. In matrix notation (2) becomes:

R=HSGF⁻¹d+N (4),

where:
G (partial replication matrix) is the matrix representing GI insertion,
d represents the modulated symbols,
F is a FFT operator matrix,
F⁻¹ is the Inverse FFT (IFFT) operator matrix,
S represents the multiplication with a scrambling sequence,
H is the matrix of the fading channel coefficients, and
N contains a vector of noise contributions.

FIG. 2 is a block diagram of a basic exemplary embodiment of the arrangement described herein.

On the transmitter (TX) side, a coded bit source 10 will output the physical bits to be transmitted on the channel between the transmitting antennas 100 and the receiving antennas 200.

A block 12 may then be optionally provided to perform a pre-equalization function in the frequency domain of the transmitted signal and/or subcarrier allocation. The operations of pre-equalization and/or subcarrier allocation are based on the estimated received Carrier-to-Interference (C/I) ratio and are described in further detail in the following.

Then a modulator block 14 is provided to modulate the physical bits allocated to a given subcarrier into a given constellation symbol. If the optional pre-equalizer/subcarrier allocation block 12 is present, the modulator 14 will be able to allocate a variable amount of power and/or bits to each subcarrier.

The transmitter described also includes an Inverse Fast Fourier Transform (IFFT) block 16, a block 18 for GI (Guard Interval) insertion and a block 20 performing time-domain scrambling.

Optionally, a training sequence (TS) generated in a TS generator block 20a can be inserted into the signal forwarded to the TX antenna(s) 100 alternated to the signal (4), with the purpose of frame and symbol synchronization and channel estimation. As schematically shown in FIG. 2, the training sequence from the TS generator block 20a can be inserted either upstream (dashed line) or downstream (chain line) of the time-domain scrambling block 20. Some of the subcarriers in formula (1) above could thus represent TS pilot signals.

OFDM systems that use frequency-domain equalization commonly adopt a TS. This can be used both for carrier frequency and symbol timing recovery, and also for achieving accurate channel knowledge. One example Is equipment complying with the IEEE802.11a-IEEE802.11g standards (e.g. Wi-Fi).

In the receiver (RX), an equalizer block 22 located downstream of the receiving antenna(s) 200 will be assumed to have knowledge about the channel state, this being able to perform equalization in the time domain or in the frequency domain.

Time-domain equalization will typically be performed with a digital multi-tap filter whose tap coefficients are updated according to one of the several algorithms available in the literature (least squares, MMSE, etc.). Channel estimation itself can be data-aided (based on a training sequence or on pilot symbols interspersed with data subcarriers) or “blind”.

Time-domain equalization as possibly performed in the arrangement described herein is well-known in the art, thus making it unnecessary to provided a more detailed description herein.

Frequency domain equalization is detailed in FIG. 3 and will be further described in the following.

The channel compensation/equalizer block 22 can also take the form of a multi-stage (e.g. a two-stage) equalization chain possibly including both stages operating in the time domain and stages operating in the frequency domain.

Still referring to FIG. 2, a block 23 performing motion speed estimation is shown. The block 23 will typically use the pilot subcarriers or a training sequence to estimate how fast the transmit channel of the useful signal changes its fading realization. If present, the block 23 will control enabling/disabling of an interference mitigation block 34 at the receiver, or a pre-equalization block 12 at the transmitter, to be further described in the following, so that interference mitigation is disabled if the variation of the speed of fading exceeds a given limit.

If one assumes that fading speed applies in the same way to both wanted signal channel and interfering signal channel, one may assume that interference estimation processing and interference mitigation processing is not useful and can be stopped above a given motion speed.

If \check{H} is the channel matrix used in channel compensation, the signal after equalization (e.g. zero-forcing equalization) becomes:

D=\check{H}⁻¹HSGF⁻¹d+N (5).

D is substantially free from inter-symbol interference (ISI) and as such can be de-scrambled in the time domain (this operation being performed by a time domain de-scrambler block 24) as follows:

B=S⁻¹D (6).

If one considers one OFDM symbol inside B, where the GI is L samples long and the data field is Q samples long, without loosing generality one can drop the index on the RX antenna:

bₖ={g_{k,1},g_{k,2}, . . . g_{k,L},d_{k,1},d_{k,2}, . . . d_{k,Q}} (7)

where the samples called g correspond to the GI, and the samples called d to the data field.

In the case of ideal symbol timing recovery one can write:

g_{k,j}=d_{k,Q-L+i}+ε_{k,i}, i=1 . . . L (8),

where ε_{k,i} is the contribution due to noise and interference and is the output of a periodic subtraction block 27.

The output ε_{k,i} depends on two samples of the interferer signal: one sampled together with g_{k,i} and one sampled together with d_{k,Q-L+i}. This point is of momentum when choosing the periodicity of the scrambling sequences.

In the presence of a symbol timing recovery error or fixed offset in the timing, the relationship (8) will no longer apply to the samples at the two extremes of the GI, which therefore will not be considered in the following paragraphs.

One may reasonably assume that the timing error δ (expressed as number of samples) is small in comparison to L.

If one assumes that:

g_{k,i}=d_{k,Q-L+i}+ε_{k,i}, i=δ . . . L−δ (9),

then:

ε_{k,i}=g_{k,i}−d_{k,Q-L+i}, i=δ . . . L−δ (10).

A more precise implementation could consider two independent offsets at the two edges: i=δ₁ . . . L−δ₂.

The estimate of one or more co-channel interferers can be computed starting from the relationship (10), with different methods depending on the embodiment. In general, the processing performing interference mitigation is carried out either on the TX or the RX side, but could also be performed on both.

The exemplary embodiment considered herein can perform interference mitigation via processing on the TX side. This essentially corresponds to the dashed lines FL that in FIG. 2 bring information from the receiver (RX) back to the transmitter (TX) via the reverse link. This information may include the output EN from the (optional) speed estimator 23.

In the embodiment described herein, various options are available for selecting the periodicity of the scrambling sequences.

A first option is to adopt scrambling sequences of periodicity Q in both the interfered and the interfering link. In this case, meaningful data about the interferer can be extracted by resorting to the relationship (10) if there is a timing offset between interfered and interfering signal. In that case, the interfering signal has a periodic component after the descrambling operation.

Another option provides for the interfered link to use a periodicity of Q samples, while the interfering link will use a periodicity that can be any other than Q (this could be e.g. several OFDM symbols of one Transmission Time Interval or TTI). In this case the process described will work even in the absence of timing offset between interfered and interfering link.

On the other hand, interference estimation could be performed in an alternate manner on the two links and so the periodicity of the scrambling sequence should be swapped regularly, e.g. every a few TTIs, among adjacent links. This assumes that at least a rough network synchronicity exists between neighboring cells.

Some examples of processing following the relationship (10) are detailed below and are performed in the scrambling/statistical processing block 26.

One will assume that the spectrum of the interferer over N sub-bands (could be less) is to be estimated. Let \tilde{ε}′ be a version of ε padded with null samples such that it fits the size of a suitable FFT operator.

The simplest way to estimate the spectrum amplitude of the interferer is to compute the FFT of the padded samples:

$${β}_{k , i}^{′} = \vert {\sum }_{n = 0}^{N - 1} {s}_{n} {\tilde{ɛ}}_{k , n}^{′} {e}^{- j 2 π ni / N} \vert , i = 0 … N . \qquad ( {11}^{′} )$$

It will be appreciated that \tilde{ε}′ is scrambled by means of the same coefficient that was originally multiplying the wanted signal in the same position. This operation gives back the correct spectral characteristic to the interfering signal. This operation is successful because sₙ, has a period of Q, so that the relationship (6) will act with the same coefficient for the two interferer samples influencing the relationship (10).

Instead of padding ε with zeros, one may also juxtapose the samples from different OFDM symbols to fill a buffer of N positions:

\tilde{ε}_{k,i}″={ε_{k,δ} . . . ε_{k,L-δ},ε_{k+1,δ} . . . } (12)

so that the relationship (11′) becomes:

$${β}_{k , i}^{′′} = \vert {\sum }_{n = 0}^{N - 1} {s}_{n} {\tilde{ɛ}}_{k , n}^{′′} {e}^{- j 2 π ni / N} \vert , i = 0 … N . \qquad ( {11}^{′′} )$$

It is also possible to apply time-windowing to the sections of juxtaposed samples.

Better results will be achieved introducing an averaging function. One can update the relationship (11′) Into a formula computing the average over V consecutive OFDM symbols:

$${β}_{k , i}^{′′′} = \frac{1}{V} {\sum }_{k = {k}_{0}}^{{k}_{0} + V} \vert {\sum }_{n = 0}^{N - 1} {s}_{n} {\tilde{ɛ}}_{k , n}^{′} {e}^{- j 2 π ni / N} \vert , i = 0 … N . \qquad ( {11}^{′′′} )$$

Otherwise one can process the coefficients defined in the relationship (12) by averaging V buffers of length N:

$${β}_{k , i}^{′′′′} = \frac{1}{V} {\sum }_{k = {k}_{0}}^{{k}_{0} + V} \vert {\sum }_{n = 0}^{N - 1} {s}_{n} {\tilde{ɛ}}_{k , n}^{′′} {e}^{- j 2 π ni / N} \vert , i = 0 … N . \qquad ( {11}^{′′′′} )$$

Similarly, β_{k,i} can also be computed as a weighted average with a given memory.

It will be appreciated that the values defined by the various versions of the relationship (11) represent an estimate of the channel of the co-channel interferers, which becomes less noisy for increasing values of V. Especially for limited mobility, the relationship (11) can prove to be an accurate estimate.

In terms of practical implementation, one may consider that the signal designated B resulting from time-domain de-scrambling as performed in the block 24 is processed as follows by the two subsequent blocks, namely a GI removal block 28 and a FFT block 30:

Y=FTB (13),

where T is the truncation matrix that removes GI.

In the a first possible implementation of the embodiment illustrated in FIG. 2, demodulation and channel decoding may simply take place in a decoding block 32, as is the case in a conventional OFDM receiver: in this case the interference mitigation block 34 shown in dashed-line is not present in the receiver.

An alternative embodiment will make use of the coefficients β_{k,i} in the receiver. The interference mitigation block 34 will thus be present to operate on the signal Y output from the FFT block as a function of the signal β from the scrambling/statistical processing block 26. This block receives input from the motion speed estimator 23, whose output also acts as an enable signal for the interference mitigation block 34. Another input to the block 26 is the signal ε obtained in a periodic subtraction block 27 fed with the signal B obtained in the time-domain de-scrambling block 24 and the signal produced by the motion speed estimator 23. The receiver itself can be single-step or iterative.

FIG. 3 refers in detail to channel compensation being performed in the frequency domain.

Frequency-domain channel compensation requires one additional FFT and one IFFT operations. By making reference to FIG. 3, the signal R received via the receiving antennas 200 and expressed in the formula (4) is first processed as follows:

D′=F⁻¹\check{H}⁻¹FTHSGF⁻¹d+N (14).

This processing corresponds to a set of cascaded blocks including a demultiplexer block 36, a FFT block 38, a channel compensation block 40 and an IFFT block 42. The channel compensation block 40 is in fact comprised of the cascade of a channel estimate block 40a and a coarse channel compensation block 40b.

The symbol T′ is used to denote the matrix complementary to T that extracts only the GI and pads it with zeros to fit the FFT size. This is performed in the demux block 36.

The GI samples are equalized as follows:

D″=F⁻¹\check{H}⁻¹FT′HSGF⁻¹d+N (15).

The time domain signal D is reconstructed by multiplexing the samples from D′ and D″ (as produced in a multiplexer block 44).

Then the steps detailed in the relationships (6) to (13) above are performed as detailed in the foregoing.

As regards the use of the coefficients β_{k,i}, in those embodiments where feedback information about the interferer is sent to the TX side (see e.g. the dashed lines FL from the receiver RX to the block 12 in the transmitter TX in FIG. 2), the feedback can be represented by a quantized version of the coefficients β_{k,i}.

The feedback can otherwise contain some kind of highly-compressed information, as exemplified below:

$${ϕ}_{k , j} = \{ \begin{matrix}1 & iff {\sum }_{i = jW}^{( j + 1 ) W - 1} \vert {β}_{k , i} \vert > {α}_{0} \\ 0 & otherwise ,\end{matrix} \qquad ( 16 )$$

where one assumes to divide the set of N subcarriers in clusters of dimension W, and α₀ is a constant threshold.

If \check{h}_{k,i} represent the channel estimates used in the relationships (5) or (14-15), k being the index of the OFDM symbol and i the subcarrier index, it is also possible to feedback a quantized version of

$$\frac{{β}_{k , i}}{{\breve{h}}_{k , i}} or \frac{{β}_{k , i}}{\vert {\breve{h}}_{k , i} \vert}$$

to compensate for the equalization that is performed on the interferer itself.

Another possibility is to feedback a quantized version of the estimated C/I ratio per cluster, namely:

$${ϕ}_{k , i} = \frac{{\sum }_{i = jW}^{( j + 1 ) W - 1} {\vert {\breve{h}}_{k , i} \vert}^{2}}{{\sum }_{i = jW}^{( j + 1 ) W - 1} {\vert \frac{{β}_{k , i}}{{\breve{h}}_{k , i}} \vert}^{2} + {n}_{k , j}^{2}} , \qquad ( 17 )$$

where n² is an estimate of the additive noise in the j-th cluster.

The transmitter will use feedback information according to a capacity maximization algorithm.

If the system has a per-subcarrier or per-cluster power control mechanism, one typical example is transmitting more power on the subcarriers where interference is lower, up to a certain maximum power level. Then starting to increase power on subcarriers where interference is stronger.

Exemplary of algorithms for capacity maximization suited for use within the context of the arrangement described herein are those disclosed e.g. in:
T. Keller and L. Hanzo, “Adaptive modulation techniques for duplex OFDM transmission”, IEEE Transactions on Vehicular Technology, vol. 49, no. 5, September 2000, pp. 1893-1906;
P. S. Chow, J. M. Cioffi, and J. A. C. Bingham, “A practical discrete multitone transceiver loading algorithm for data transmission over spectrally shaped channels”, IEEE Transactions on Communications, vol. 43, no. 2/3/4, February/March/April 1995, pp. 773-775; and
A. Goldsmith and Soon-Ghee Chua, “Adaptive coded modulation for fading channels”, IEEE Transactions on Communications, vol. 46, no. 5, May 1998, pp. 595-602.

Without prejudice to the underlying principles of the invention, the details and the embodiments may vary, even appreciably, with reference to what has been described by way of example only, without departing from the scope of the invention as defined by the annexed claims.

1-29. (canceled)

30. A method of multicarrier transmission between at least one transmitting antenna and at least one receiving antenna, wherein signals forwarded for transmission toward said at least one transmitting antenna are subject to addition of a guard interval and to scrambling in the time domain and wherein signals conveyed from said at least one receiving antenna after reception are subject to removal of said guard interval and to de-scrambling in the time domain, comprising the steps of:
subjecting said signals toward said at least one transmitting antenna to scrambling in the time domain after the addition of said guard interval; and
subjecting said signals from said at least one receiving antenna to de-scrambling in the time domain before the removal of said guard interval.

31. The method of claim 30, wherein said signals are orthogonal frequency division multiplexing signals.

32. The method of claim 30, comprising the step of subjecting said signals toward said at least one transmitting antenna to conversion from the frequency domain to the time domain before the addition of said guard interval.

33. The method of claim 30, comprising the step of subjecting said signals from said at least one receiving antenna to conversion from the time domain to the frequency domain after the removal of said guard interval.

34. The method of claim 30, comprising the step of inserting a training sequence in said signals toward said at least one transmitting antenna.

35. The method of claim 30, comprising the step of subjecting said signals from said at least one receiving antenna to equalization in the frequency domain by the operations of:
converting the signals subject to equalization from the time domain to the frequency domain;
subjecting the signals thus converted to the frequency domain to channel compensation; and
subjecting the thus channel-compensated signals to conversion from the frequency domain back to the time domain.

36. The method of claim 35, comprising the steps of:
subjecting to said equalization in the frequency domain separately, the data portion and the guard interval portion of said signals from said at least one receiving antenna; and
recombining said data portion and said guard interval portion of said signals from said at least one receiving antenna after said equalization in the frequency domain.

37. The method of claim 30, comprising the step of estimating, as a function of the signals from said at least one receiving antenna, the transmission channel of at least one signal interfering with said signals from said at least one receiving antenna.

38. The method of claim 37, wherein said step of estimating the transmission channel of said at least one interfering signal comprises the operation of subtracting from each other, in said signals from said at least one receiving antenna after said de-scrambling in the time domain, the data portion and corresponding guard interval portion, whereby a signal resulting from said subtraction is a non-periodical signal representative of said at least one interfering signal.

39. The method of claim 37, comprising the steps of:
performing frequency domain pre-equalization of said signals toward said at least one transmitting antenna, and
driving said frequency domain pre-equalization as a function of said transmission channel of said at least one interfering signal as estimated as a function of the signals from said at least one receiving antenna.

40. The method of claim 39, wherein said frequency domain pre-equalization comprises allocating the power of said signals toward said at least one transmitting antenna primarily to the parts of the spectrum of said signals which are less affected by said at least one interfering signal.

41. The method of claim 39, comprising the steps of:
generating a signal indicative of a speed of fading that affects transmission between said at least one transmitting antenna and said at least one receiving antenna, and
disabling said frequency domain pre-equalization if a variation of said speed of fading exceeds a given limit.

42. A transmitter for transmitting multicarrier signals via at least one transmitting antenna, comprising a guard interval addition block and a time-domain scrambling block for subjecting the signals forwarded for transmission toward said at least one transmitting antenna to addition of a guard interval and to scrambling in the time domain, wherein said time-domain scrambling block is arranged downstream of said guard interval addition block, whereby said signals toward said at least one transmitting antenna are subject to scrambling in the time domain after the addition of said guard interval.

43. The transmitter of claim 42, wherein said signals are orthogonal frequency division multiplexing signals.

44. The transmitter of claim 42, comprising a frequency-to-time converter for subjecting said signals toward said at least one transmitting antenna to conversion from the frequency domain to the time domain, said frequency-to-time converter being arranged upstream of said guard interval addition block.

45. The transmitter of claim 42, comprising a sequence generator for generating a training sequence of pilot symbols for insertion in said signals toward said at least one transmitting antenna.

46. The transmitter of claim 42, comprising a frequency domain pre-equalization block of said signals toward said at least one transmitting antenna, said frequency domain pre-equalization block capable of being configured for being driven by feedback estimation of the transmission channel of at least one signal interfering with signals from at least one receiving antenna at a receiver.

47. The transmitter of claim 46, wherein said frequency domain pre-equalization block capable of being configured for allocating power of said signals toward said at least one transmitting antenna primarily to the parts of a spectrum of said signals which are less affected by said at least one interfering signal.

48. The transmitter of claim 46, wherein said frequency domain pre-equalization block is selectively de-activatable as a function of a signal indicative of the speed of fading that affects transmission between said at least one transmitting antenna and said at least one receiving antenna.

49. A receiver for receiving multicarrier signals via at least one receiving antenna, comprising a guard interval removal block and a time-domain de-scrambling block for subjecting signals conveyed from said at least one receiving antenna after reception to removal of a guard interval and to de-scrambling in the time domain, wherein said time-domain de-scrambling block is arranged upstream of said guard interval removal block, whereby said signals from said at least one receiving antenna are subject to de-scrambling in the time domain before the removal of said guard interval.

50. The receiver of claim 49, wherein said signals are orthogonal frequency division multiplexing signals.

51. The receiver of claim 49, comprising a time-to-frequency converter block for subjecting said signals from said at least one receiving antenna to conversion from the time domain to the frequency domain, said time-to-frequency converter block being arranged after said guard interval removal block.

52. The receiver of claim 49, comprising an equalizer structure for subjecting to equalization said signals from said at least one receiving antenna, wherein said equalizer structure operates in the frequency domain and comprise:
a respective time-to-frequency converter for converting the signals subject to equalization from the time domain to the frequency domain;
a channel compensator for subjecting to channel compensation the signals converted to the frequency domain by said respective time-to-frequency converter; and
a respective frequency-to-time converter for subjecting the signals channel-compensated in said channel compensator to conversion from the frequency domain back to the time domain.

53. The receiver of claim 52, comprising:
a de-multiplexer block arranged at the input of said equalizer structure for separating a data portion and a guard interval portion of said signals from said at least one receiving antenna subject to said equalization in the frequency domain; and
a multiplexer block arranged at the output of said equalizer structure for recombining said data portion and said guard interval portion of said signals from said at least one receiving antenna after said equalization in the frequency domain.

54. The receiver of claim 49, comprising channel estimation circuitry for estimating, as a function of the signals from said at least one receiving antenna, a transmission channel of at least one signal interfering with said signals from said at least one receiving antenna.

55. The receiver of claim 54, wherein said channel estimation circuitry comprises a subtractor block for subtracting from each other, in said signals from said at least one receiving antenna after said de-scrambling in the time domain, a data portion and corresponding guard interval portion, whereby output signal from said subtractor block is a non-periodical signal representative of said at least one interfering signal.

56. The receiver of claim 54, wherein said channel estimation circuitry is configured for transmitting a signal representative of said transmission channel of at least one signal interfering with said signals from said at least one receiving antenna for driving frequency domain pre-equalization of signals transmitted toward the receiver.

57. The receiver of claim 56, comprising a speed estimator for generating a signal indicative of a speed of fading that affects transmission between said at least one transmitting antenna and said at least one receiving antenna, said speed signal capable of being adapted for disabling said frequency domain pre-equalization if variation of said speed of fading exceeds a given limit.

58. A computer program product, loadable in the memory of at least one computer and comprising software code portions capable of performing the method of claim 30.
